(19) United States
(12) Patent Application Publication
(10) Pub. No.: US 2026/0341137 A1
(43) Pub. Date: Oct. 29, 2026

(54) INTELLIGENT EARLY FIRE DETECTION AND INTELLIGENT CONDITION MONITORING SYSTEM AND METHOD

(71) Applicant: Epsilon Technologies International, LLC dba MoviTHERM, Irvine, CA (US)

(72) Inventors: Markus Tarin, Irvine, CA (US); Nathan Aday, CA, CA (US)

(21) Appl. No.: 19/646,953

(22) Filed: Apr. 14, 2026

Related U.S. Application Data
(63) Continuation of application No. 19/407,442, filed on Dec. 3, 2025.
(60) Provisional application No. 63/793,420, filed on Apr. 23, 2025.

(51) Int. Cl. G08B 17/12; A62C 37/40

(52) U.S. Cl. CPC G08B 17/12; A62C 37/40

(57) ABSTRACT

A hotspot detection system, including at least one camera to monitor a location and a device, and detect a hotspot at the location and the device based on at least one of a fire, an imminent fire, a temperature level, a gateway device, a plurality of network connectors disposed on at least a portion of the base to connect to a network and the at least one camera, and/or a processing unit to connect the at least one camera based on a driver program for the gateway device, the processing unit to receive data from the at least one camera and generate a safety response in response to the data indicating presence of the hotspot, and a control device configured to receive the data from the gateway device and generate at least one of a report, a warning, and an alarm based on the data.

### CROSS-REFERENCE TO RELATED APPLICATION

This application incorporates by reference and claims the benefit of priority to U.S. Provisional Application 63/793,420 filed on Apr. 23, 2025 and is a continuation of U.S. Non-Provisional Application 19/407,442 filed on Dec. 3, 2025.

### BACKGROUND OF THE INVENTION

### 1. Field of the Invention

This invention relates to intelligent monitoring systems for hazard detection and asset monitoring. More particularly, the invention relates to an IoT Cloud based intelligent monitoring system and method useful in detecting early stage fires and monitoring the condition of critical assets and equipment.

### 2. Description of the Related Art

In markets today, there are very limited products offered for early fire detection and condition monitoring that provide both edge-based intelligence and cloud integration. Traditional fire detection systems typically rely on smoke detectors that only activate once a fire has already developed to a dangerous level, often resulting in significant damage before detection occurs.

Additionally, current condition monitoring systems for critical infrastructure and industrial equipment often lack integration with fire detection capabilities, requiring separate systems that increase complexity and cost while reducing overall situational awareness.

Many existing solutions lack redundancy features that would allow for continued operation during network outages, potentially creating dangerous gaps in monitoring coverage during critical moments. Furthermore, systems that do offer early detection typically lack effective means of notification and situational awareness capabilities for emergency responders.

Currently, there are no useful alternatives that effectively assist in providing a comprehensive monitoring solution that combines early fire detection with condition monitoring, offers both cloud and edge-based intelligence, and provides robust notification systems with situational awareness for first responders. As will be disclosed below, the present disclosure addresses these needs and covers a system and method to detect fires at their earliest stages and monitor critical asset conditions to prevent disasters and solve these issues.

### SUMMARY OF THE INVENTION

In one aspect, the present invention is embodied as an IoT Cloud based intelligent monitoring system for hot spot monitoring for early fire detection as well as machine and critical asset condition monitoring.

In one embodiment, the present disclosure is embodied as a system comprising edge-based cameras (thermal and daylight), sensors (temperature, gas, smoke detectors and other sensors), and an intelligent gateway device, with the gateway providing real-time processing and redundancy from the cloud platform.

In another embodiment, the disclosure is embodied as a gateway device running a Linux OS and custom firmware with AI/Machine learning hardware on board as well as industrial digital I/O for acting on warnings and alarms to turn processes on or off, independent of the IoT Cloud in real-time.

In an alternative embodiment, the system includes an IoT Cloud web-based monitoring platform providing customer and site level overview of warnings and alarm conditions with situational awareness and real-time updates to users, including mass notification via email, SMS text messaging as well as voice calling.

In accordance with one form of this disclosure, there is provided a method for providing situational awareness to first responders by dynamically creating and sending URL links to maps showing the location of detected hotspots and providing access routes and critical infrastructure information.

Before explaining the various embodiments of the invention in detail, it is to be understood that the invention is not limited in its application to the details of construction and to the arrangements of the components set forth in the following description or illustrated in the drawings. Rather, the invention is capable of other embodiments and of being practiced and carried out in various ways. Also, it is to be understood that the terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

For a better understanding of the invention, its operating advantages and the specific objects attained by its uses, reference should be made to the accompanying drawings and descriptive matter in which there are illustrated preferred embodiments of the invention.

Various objects, features, aspects and advantages of the present embodiment will become more apparent from the following detailed description of embodiments of the embodiment, along with the accompanying drawings in which like numerals represent like components.

### BRIEF DESCRIPTION OF THE DRAWINGS

The present disclosure may be better understood, and its numerous features and advantages made apparent and readily appreciated to those skilled in the art, by referencing the accompanying drawings.

FIG. 1 is a block diagram of an intelligent condition monitoring system in accordance with some embodiments.

FIG. 2A is a perspective view of a camera used to monitor conditions in accordance with some embodiments.

FIG. 2B is an elevational rear view of a camera used to monitor conditions in accordance with some embodiments.

FIG. 3A is a perspective view of a gateway device that generates a response based on conditions in accordance with some embodiments.

FIG. 3B is a perspective view of a gateway device that generates a response based on conditions in accordance with some embodiments.

FIG. 4 is a flow diagram illustrating a method for generating a response based on conditions in accordance with some embodiments.

The same elements or parts throughout the figures of the drawings are designated by the same reference characters.

### DETAILED DESCRIPTIONOF THE INVENTION

The embodiment and various embodiments can now be better understood by turning to the following detailed description of the embodiments, which are presented as illustrated examples of the embodiment defined in the claims. It is expressly understood that the embodiment as defined by the claims may be broader than the illustrated embodiments described below. Many alterations and modifications may be made by those having ordinary skill in the art without departing from the spirit and scope of the embodiments.

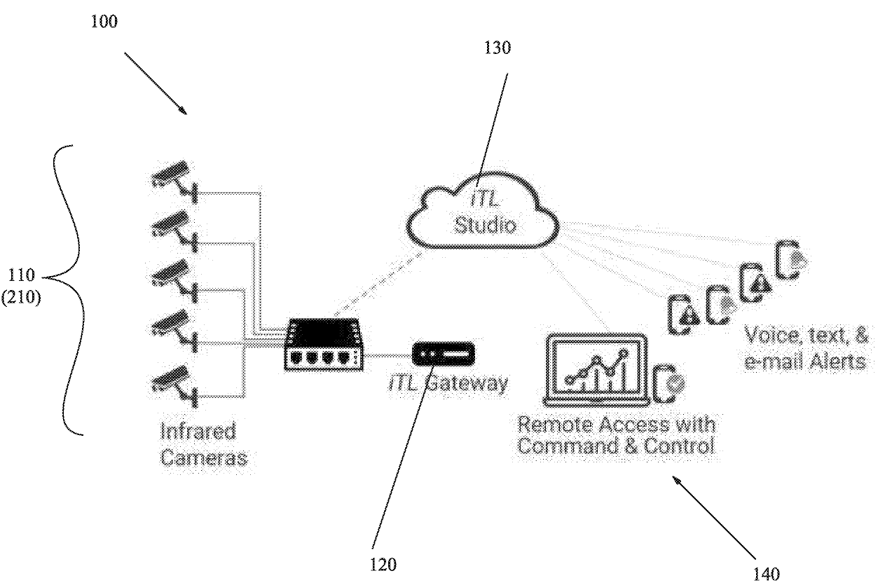

FIG. 1 is a block diagram of an intelligent condition monitoring system 100 in accordance with some embodiments. The intelligent condition monitoring system (iCM) 100 is a system that generally monitors conditions and/or events. In particular, the iCM system 100 is configured to monitor for hotspots, dangers, and/or hazards at a location and/or a device. For example, the iCM system 100 monitors a home and/or a vehicle located at the home for a fire and/or an imminent fire (i.e., a precursor to a fire). In some embodiments, the iCM system 100 includes a plurality of cameras 110, a plurality of sensors 210, a gateway device 120, and a control device 130, but is not limited thereto.

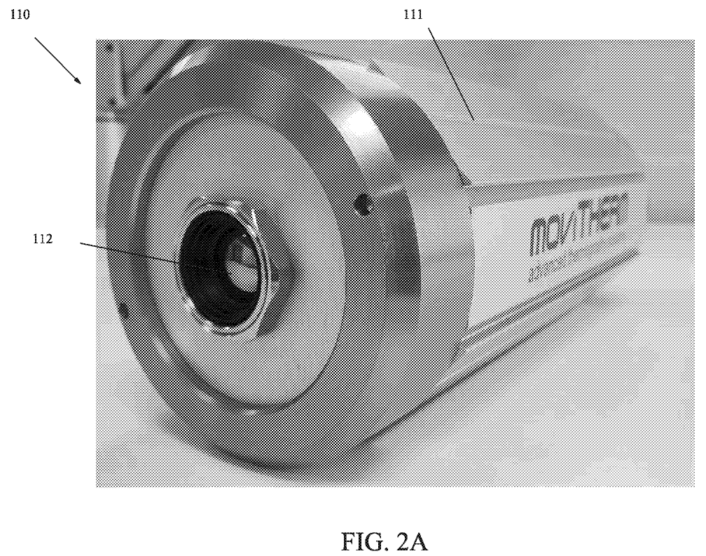

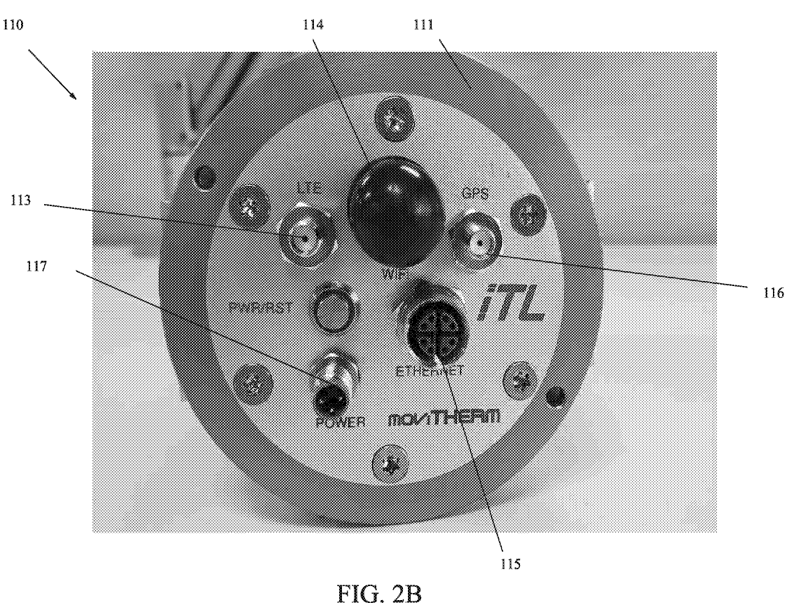

FIG. 2A is a perspective view of a camera 110 used to monitor conditions in accordance with some embodiments.

FIG. 2B is an elevational rear view of a camera 110 used to monitor conditions in accordance with some embodiments. In some embodiments, each of the plurality of cameras 110 is a thermal imaging camera (i.e., infrared radiation (IR) camera) and/or a daylight camera. However, in different embodiments, each of the plurality of cameras 110 are constructed as any type of camera known to one of ordinary skill in the art, including, but not limited to, an action camera, an animation camera, an to focus camera, a box camera, a camcorder, a camera phone, a compact camera, a dashboard camera (i.e., a Dashcam), a digital camera, a field camera, a FIREWIRE camera, a helmet camera, a high-speed camera, an instant camera, a keychain camera, a live-preview digital camera, a movie camera, an omnidirectional camera, a pinhole camera, a pocket camera, a pocket video camera, a rangefinder camera, a reflex camera, a remote camera, a stereo camera, a still camera, a still video camera, a subminiature camera, a system camera, a thermographic camera, a traffic camera, a traffic enforcement camera, a twin-lens reflex camera, a video camera, a view camera, a webcam, a WRIGHT camera, a ZENITH camera, and a zoom-lens reflex camera.

Referring to FIGS. 2A and 2B, each of the plurality of cameras 110 includes a body 111, a lens 112, a Long-Term Evolution (LTE) connector 113, a Wi-Fi connector 114, an Ethernet connector 115, a global positioning system (GPS) connector 116, and a power connector 117, but is not limited thereto. In the depicted example of FIG. 2A, the body 111 is constructed as an elongated and cylindrical structure. However, in different embodiments, the body 111 may have any shape, such as rectangular, triangular, circular, pentagonal, hexagonal, heptagonal, or octagonal. The lens 112 is disposed at a first end of the body 111 and receives visual data therein. The LTE connector 113 is disposed at a second end of the body 111 and is configured to receive an LTE wire therein. The Wi-Fi connector 114 is disposed at the second end of the body 111 and is configured to receive a Wi-Fi wire therein. Alternatively, and/or in addition thereto, the Wi-Fi connector 114 facilitates wireless connectivity to an external device. The Ethernet connector 115 is disposed at the second end of the body 111 and is configured to receive an Ethernet wire therein. The GPS connector 116 is disposed at the second end of the body 111 and is configured to receive a GPS wire therein. Lastly, the power connector 117 is disposed at the second end of the body 111 and is configured to receive a power wire therein, and receives power therein to provide power to the camera 110.

Each of the plurality of cameras 110, or alternatively, a single camera 110, are disposed at the location to monitor the location and/or the device. In some embodiments, each of the plurality of cameras 110 include pan, tilt, and zoom (PTZ) functionality. That is, each of the plurality of cameras 110 move (i.e., rotate, pivot) in a first lateral direction (i.e., left) or a second lateral direction (i.e., right) on a first axis (i.e., a horizontal axis). Moreover, each of the plurality of cameras 110 move in a first vertical direction (i.e., up) or a second vertical direction (i.e., down) on a second axis (i.e., a horizontal axis) angularly (i.e., perpendicular) disposed with respect to the first axis. Lastly, each of the plurality of cameras 110 move (i.e., rotate) a lens portion to perform zoom, which includes both optical zoom and digital zoom. In some embodiments, each of the plurality of cameras 110 zoom on a camera region (i.e., location, object, etc.) within view of at least one of the plurality of cameras 110 to dwell and/or focus on the camera region before moving to another camera region. An operator and/or user of at least one of the plurality of cameras 110 can initiate manual control of at least one of the plurality of cameras 110 in response to at least one of the plurality of cameras 110 identifying a location, a device, and/or the hotspot in the camera region.

Alternatively, and/or in addition thereto, in some embodiments, each of the plurality of cameras 110 is connected to a rail. Specifically, each of the plurality of cameras 110 is connected to a rail is connected to a rail or a track, such that each of the plurality of cameras 110 moves linearly along the rail. However, each of the plurality of cameras 110 still maintains PTZ functionality while disposed on the rail. In some embodiments, each of the plurality of cameras 110 on the rail is powered via an internal power source (e.g., a battery, a solar panel, and the like). In different embodiments, each of the plurality of cameras 110 receives power from the rail. In other words, the rail provides power to each of the plurality of cameras 110 while each of the plurality of cameras 110 is connected to the rail. As such, for example, the plurality of cameras 110 monitor a long and narrow hallway, while having more range of movement than fixed mount cameras.

In some embodiments, the plurality of cameras 110 are residential Wi-Fi cameras. That is, each of the plurality of cameras 110 connect to a local area network (LAN), such as a residential Wi-Fi network. As such, the plurality of cameras 110 monitor a home and/or devices, such as an electric vehicle and/or a charging station.

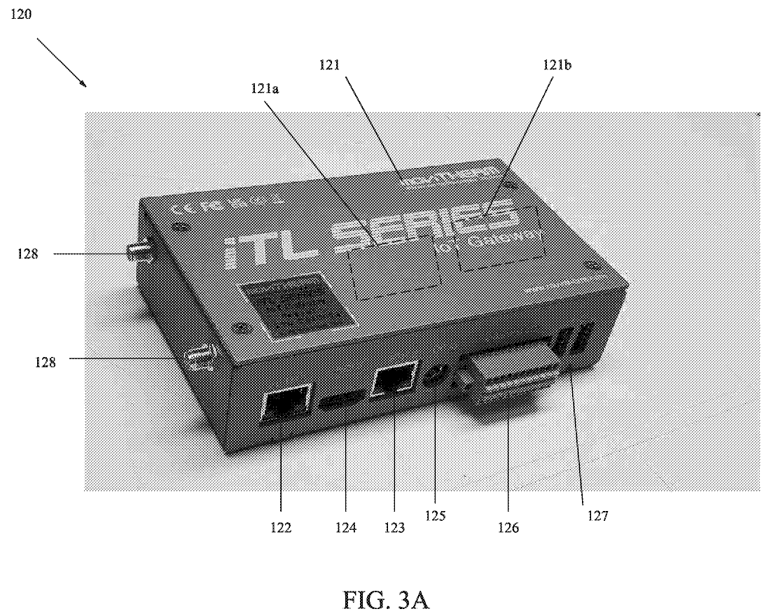

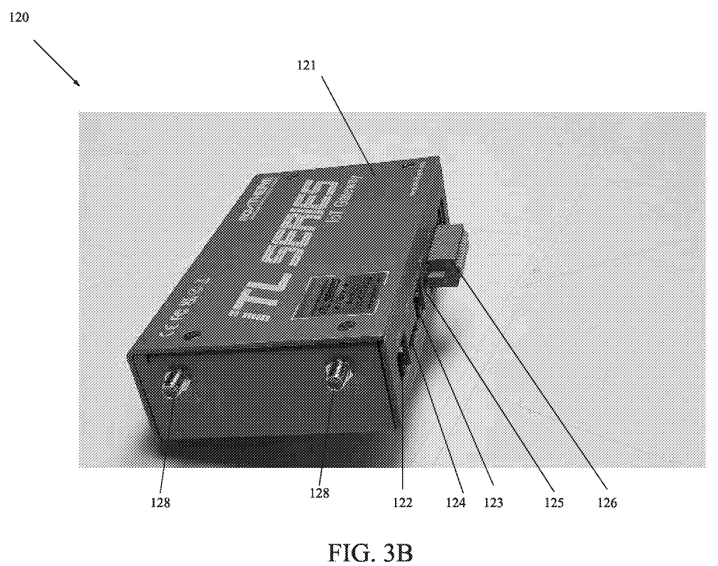

FIG. 3A is a perspective view of a gateway device 120 that generates a response based on conditions in accordance with some embodiments.

FIG. 3B is a perspective view of a gateway device 120 that generates a response based on conditions in accordance with some embodiments. In some embodiments, the gateway device 120 includes a base (i.e., a housing) 121, a processing unit (i.e., a central processing unit (CPU), a microprocessor, a microcontroller) 121a, and a memory unit (i.e., random-access memory (RAM), read-only memory (ROM), a hard drive, a solid state drive (SSD), a flash drive, a cloud storage drive) 121b, a first Ethernet port 122, a second Ethernet port 123, a high-definition multimedia interface (HDMI) port 124, a power port (e.g., direct current (DC) in) 125, an industrial I/O port 126, a plurality of USB ports 127, and a plurality of LTE ports 128, but is not limited thereto. In the depicted examples of FIGS. 3A and 3B, the base 121 the body 111 is constructed as a rectangular structure. However, in different embodiments, the base 121 may have any shape, such as cylindrical, triangular, circular, pentagonal, hexagonal, heptagonal, or octagonal. The processing unit 121a is disposed within the base 121 and executes instructions, operations, or both based on a program and/or firmware. The memory unit 121b is disposed within the base 121 and stores the program and/or firmware as well as the results of the executed instructions and data generated from the instructions, operations, or both.

The first Ethernet port 122 is disposed on at least a portion of the base 121. The first Ethernet port 122 receives and connects to a first Ethernet wire therein. Similarly, the second Ethernet port 123 is disposed on at least a portion of the base 121. The second Ethernet port 123 receives and connects to a second Ethernet wire therein. The HDMI port 124 is disposed on at least a portion of the base 121. The HDMI port 124 receives and connects to an HDMI wire therein. The power port 125 is disposed on at least a portion of the base 121. The power port 125 receives and connects to a power wire therein. The industrial I/O port 126 is disposed on at least a portion of the base 121. The industrial I/O port 126 receives and connects to an industrial I/O wire therein. As such, the gateway device 120 connects to an external system, such as a fire alarm system, a fire suppression system, audible and visual alarm beacons, programmable logic controllers (PLC), and/or any other machine or hardware for an existing system. In this manner, the gateway device 120 controls and can send commands to the external system, such as turning on and/or off a fire alarm and/or a fire sprinkler system. The plurality of USB ports 127 are disposed on at least a portion of the base 121. Each of the plurality of USB ports 127 receives and connects to a USB wire (e.g., USB-A, USB-B, USB-C) therein. Thus, the gateway device 120 may connect to an external device, such as the plurality of cameras 110 via at least one of the plurality of USB ports 127. The plurality of LTE ports 128 are disposed on at least a portion of the base 121. Each of the plurality of LTE ports 128 receives and connects to an LTE wire therein.

In some embodiments, the gateway device 120 is configured with dual-core subscriber identity module (SIM) cards with data plans based on the plurality of LTE ports 128. The dual-core SIM cards operate as a fail-safe to use different cellular networks in response to lost signals and/or weak signals on the cellular network for one of the dual cores. The dual core SIM cards use LTE 4G. However, in different embodiments, the dual SIM cards use LTE 5G.

In some embodiments, the gateway device 120 includes artificial intelligence (AI) and/or machine learning hardware and/or software. The gateway device 120 receives data from each of the plurality of cameras 110 to monitor for a hotspot, a dangerous condition, and/or a hazard, such as a fire and/or an imminent fire at the location and/or the device. The gateway device 120 may be trained on large sets of data to enable the AI to accurately and quickly identify whether the data monitored is a hotspot. For example, the plurality of cameras 110 track thermal information (e.g., IR emissions, IR light, IR radiation), such as temperature levels, gas, smoke. The gateway device 120 using the AI includes filtering and classification algorithms to reduce incidence of false alarms. The gateway device 120 generates a safety response in response to detecting the hotspot. For example, the gateway device 120 turns on the alarm system, turns on the sprinkler system, and/or sends alert to a first responder (e.g., police, fire department, ambulance). The gateway device 120 is connected to each of the plurality of cameras 110 with multiple communication protocols including MQTT, RestAPI, ModBUS TCP, JASON, HTTP requests, and the like.

The gateway device 120 includes power over Ethernet (POE) capabilities. In particular, the gateway device 120 receives full power through connection in the first Ethernet port 122 and/or the second Ethernet port 123 in lieu of and/or in addition to power from the power port 125. As such, the gateway device 120 simplifies installation and wiring costs. The gateway device 120 is accessible and configurable via at least one external device 140 and includes a web browser based interface or any other connection interface (e.g., operating system, connection program). In particular, the gateway device 120 is connected to and accessed via an IP address. Moreover, the gateway device 120 connects to each of the plurality of cameras 110 using a driver and/or other program specific and unique to each of the plurality of cameras 110. The gateway device 120 only recognizes specific cameras 110 based on the driver. Also, the gateway device 120 automatically sets up at least one of the plurality of cameras 110 for use by the gateway device 120 and the control device 130, and generates an interface in response to connecting at least one of the plurality of cameras 110 to the gateway device 120. Specifically, the interface generated by the gateway device 120 includes an interface widget, a graphical user interface (GUI), a software application (i.e., an app), and the like.

Alternatively, and/or in addition thereto, the gateway device 120 connects to each of the plurality of sensors 210 using a driver and/or other program specific and unique to each of the plurality of sensors 210. The gateway device 120 is connected to each of the plurality of sensors 210 using a wired connection and/or a long-range (LoRa) wide-area network (WAN) (LoRaWAN) gateway. Additionally, the gateway device 120 is connected to each of the plurality of sensors 210 via the control device 130 (e.g., over the cloud). The gateway device 120 only recognizes specific sensors 210 based on the driver. Also, the gateway device 120 automatically sets up at least one of the plurality of sensors 210 for use by the gateway device 120 and the control device 130, and generates an interface specific (i.e., unique) to each of the plurality of sensors 210 in response to connecting at least one of the plurality of sensors 210 to the gateway device 120. Specifically, the interface generated by the gateway device 120 includes an interface widget, a graphical user interface (GUI), a software application (i.e., an app), and the like. For example, the gateway device 120 generates the interface for a first of the plurality of sensors 210 that is different from the interface for a second of the plurality of sensors 210. In particular, the first of the plurality of sensors 210 has a first GUI and/or a first control scheme that differs and does not include commands or tools in a second GUI and/or a second control scheme for the second of the plurality of sensors 210.

In some embodiments, each of the plurality of sensors 210 includes a temperature sensor, a gas sensor, a smoke detector, and an outgassing sensor, but is not limited thereto. Specifically, each of the plurality of sensors 210 detects a temperature level and/or changes in the temperature level as the temperature sensor. Also, each of the plurality of sensors 210 detects a gas level, changes in the gas level, and a gas type as the gas sensor. Also, each of the plurality of sensors 210 detects a smoke level and/or changes in the smoke level as the smoke detector. Also, each of the plurality of sensors 210 detects a temperature level, changes in the temperature level, and/or a gas based on a battery chemistry (e.g., a battery from an electric vehicle, EV) as the outgassing sensor. To illustrate via an example, at least one of the plurality of sensors 210 may be an outgassing sensor configured to monitor an EV, such that the outgassing sensor monitors a temperature level, changes in the temperature level, and/or gas emissions from a battery of the EV. Moreover, the outgassing sensor 210 sends the data to the gateway device 120 and/or the control device 130, such that the gateway device 120 and/or the control device 130 determine whether the temperature level and/or the gas emissions meet a threshold that indicates a hotspot (e.g., a danger, a fire, an imminent fire).

In some embodiments, the control device 130 includes a computing device (e.g., a desktop computer, a laptop computer, a smartphone, a tablet computer, a cloud computer, a terminal, a workstation, a mouse, a keyboard, a game console, and the like). The control device 130 operates over a network, such as the cloud. The control device 130 executes instructions, operations, or both based on a program and/or firmware, and operates independently or collaboratively with the gateway device 120. The gateway device 120 is connected to the control device 130 over a cellular connection, such as at least one of the plurality of LTE ports 128, the first Ethernet port 122, and/or the second Ethernet port 123. Based on the plurality of LTE ports 128, the gateway device 120 detaches the gateway device 120 from an existing network and ensuring security of the gateway device 120, the plurality of cameras 110, and/or the plurality of sensors 210. In other words, the gateway device 120 and/or the plurality of cameras 110 are not accessible over a LAN, while the gateway device 120 is only connected via at least one of the plurality of LTE ports 128.

The control device 130 monitors the data from the plurality of cameras 110 and/or the plurality of sensors 210, and generates a report, a warning, and/or an alarm in real-time. Specifically, the control device 130 sends notifications of the report, the warning, and/or the alarm to the at least one external device 140 over at least one messaging platform, such as email, short message service (SMS) text, voice calling, digital messaging, and/or social media platforms. Moreover, the control device 130 sends the notifications based on occurrence of events, such as detecting the hotspots. The control device 130 is configured with situational awareness. The control device 130 transmits a dynamically created uniform resource locator (URL) link in response to generating the alarm from the hotspot. As such, the recipient of the notification does not need to have login information or be an administrator of the control device 130. Any recipient will be able to view the information based on the alarm in the URL link including the map overlay, such as location and/or device affected by the condition. The early detection capabilities in real-time of the gateway device 120 and/or the control device 130 allow anyone including first responders to have real-time information of the situation. The control device 130 will constantly and update the information in the URL link in real-time. For example, the control device 130 will update the best access points to the facility, locations of gas, water and electrical shut off valves, the location and data of all sensors and cameras.

Although the control device 130 receives the data from the plurality of cameras 110, the plurality of sensors 210, and/or the data based on the gateway device 120 detecting the hotspots, the data is adjusted for the hotspots, such that data rate (i.e., speed of data transfer) and data storage restrictions (i.e., storage limits) are increased for the hotspots. However, in cases where the gateway device 120 uses only the plurality of LTE ports 128, the gateway device 120 throttles the data rate. As such, the gateway device 120 dynamically changes the data rate during detected events. After the event has passed, the control device 130 notifies users of the end of the alarm. That is, the control device 130 automatically removes the alarm from notification, and the gateway device 120 disables the alarm system, the sprinkler system, and/or the alert to the first responder.

The gateway device 120 and/or the control device 130 use a map overlay. In other words, the gateway device 120 and/or the control device 130 display on a display (not shown) warnings of the hotspot on the map overlay at the location and/or the device based on at least one of the report, the warning, and the alarm. The gateway device 120 and/or the control device 130 superimpose a map of detected hotspots on a visual map of the location (e.g., a facility, building, etc.). Also, the control device 130 highlights the location and/or the device on the map overlay. The map overlay changes color from a first color (i.e., green) with no warnings or alarms to a second color (i.e., red) to indicate the warning or alarms. Furthermore, the plurality of cameras 110, the gateway device 120, the control device 130, and/or the plurality of sensors 210 include false alarm mitigation processes. For example, the control device 130 includes schedule based alarming to suppress alarms during specific time periods, such as times where an elevated temperature level may be expected. To illustrate, the plurality of cameras 110 and/or the plurality of sensors 210 monitor a location where delivery vehicles enter with hot engines or exhaust. Additionally, the gateway device 120 and/or the control device 130 includes region of interest mitigation. To illustrate, the gateway device 120 and/or the control device 130 mark a region (e.g., a circle, rectangle, points, polygons) on the map overlay, such that only those regions are monitored. Conversely, unmarked regions are excluded and not monitored, such as areas where a pipe emits steam or smoke. The control device 130 further includes AI based filtering and/or machine learning. To illustrate, the control device 130 and/or the gateway device 120 may use the AI to analyze a flame or hotspot and determine whether it is an actual hotspot (e.g., an imminent fire) or a vehicle exhaust and not a hotspot. Alternatively, and/or in addition thereto, in some embodiments, each of the plurality of cameras 110 and/or each of the plurality of sensors 210 include such AI based filtering. That is, each of the plurality of cameras 110 and/or each of the plurality of sensors 210 use the AI based filtering to remove false alarm cases from the data sent to the gateway device 120 and/or the control device 130. The plurality of cameras 110, the plurality of sensors 210, the gateway device 120, and/or the control device 130 use the AI based filtering to disregard the data indicating the hotspot that is based on reflection of light and/or heat (i.e., infrared radiation) from a metallic object, such as light from the Sun. The control device 130 further includes temporal based filtering. To illustrate, the control device 130 is configured with a rate of change of temperature level for a specific region. Thus, the control device 130 only triggers an alarm based on rate of change of the temperature level above or below a threshold. Lastly, the gateway device 120 and/or the control device 130 includes a time delay alarm. To illustrate, the gateway device 120 and/or the control device 130 includes a time delay before triggering the alarm.

In some embodiments, at least one of the plurality of cameras 110 is configured to include the gateway device 120 and/or the control device 130 as part of the camera 110. That is, at least one of the plurality of cameras 110 is a complete system in itself and can automatically set up to monitor and track conditions without use of an external system, such as the gateway device 120 and/or the control device 130 as separate devices.

In different embodiments, each of the plurality of sensors 210 include a global positioning system (GPS) device and a geolocation tracking device, but is not limited thereto. In particular, the GPS device and/or the geolocation tracking device track location and/or movement of each of the plurality of sensors 210 (e.g., gas sensor, smoke detector, outgassing sensor) and/or each of the plurality of cameras 110, vehicles, and/or other assets in real-time. As such, the plurality of sensors 210, the plurality of cameras 110, the vehicles, and/or other assets can be tracked, logged, reported, displayed or generate an alarm on the gateway device 120 and/or the control device 130 based on geolocation and/or geofencing. Accordingly, mobile assets such as trucks, cars, ships, containers, trains, planes, drones, busses, mobile robots, parts on a conveyor belt, etc. is monitored via the GPS device and/or the geolocation tracking device. In this manner, false alarms are suppressed, such as by tracking movement of the vehicle via GPS that is emitting hot engine or hot exhaust that is monitored by at least one of the plurality of cameras 110 and/or at least one of the plurality of sensors 210.

In some embodiments, the iCM system 100 keeps an audit trail of all notifications sent out to recipients, providing critical proof of notification for management and accountability purposes. The iCM system 100 as described represents an innovative approach to early fire detection and condition monitoring, combining edge-based intelligence with cloud capabilities, comprehensive notification systems, and enhanced situational awareness tools that significantly improve response times and effectiveness.

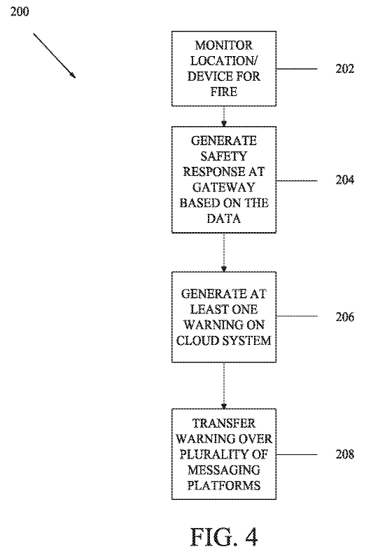

FIG. 4 is a flow diagram illustrating a method 200 for generating a response based on conditions in accordance with some embodiments. The method 200 is described with respect to an example implementation of the iCM system 100 of FIGS. 1-3B. At block 202, each of the plurality of cameras 110 and/or each of the plurality of sensors 210 monitor the location and/or the device for hotspots, dangers, and/or hazards, such as a fire and/or an imminent fire. At block 204, the gateway device 120 receives data from each of the plurality of cameras 110 and/or each of the plurality of sensors 210 to monitor for a hotspot (i.e., a dangerous condition and/or hazard). The gateway device 120 generates a safety response in response to detecting the dangerous condition. Specifically, the gateway device 120 turns on the alarm system, turns on the sprinkler system, and/or sends alert to a first responder.

At block 206, the control device 130 generates warnings in real-time. At block 208, the control device 130 sends notifications over at least one messaging platform, such as email, short message service (SMS) text, voice calling, digital messaging, and/or social media platforms. Moreover, the control device 130 sends the notifications based on occurrence of events, such as detecting the dangerous conditions.

As mentioned above, other embodiments and configurations may be devised without departing from the spirit of the invention and the scope of the appended claims.

1. A hotspot detection system, comprising:
at least one camera configured to monitor at least one of a location and a device, and detect a hotspot at the location and the device based on at least one of a fire, an imminent fire, a temperature level exceeding a threshold temperature level, a flame, and a smoke emission;
a gateway device, comprising:
a base,
a plurality of network connectors disposed on at least a portion of the base to connect to a network and the at least one camera, and
a processing unit disposed within the base and accessed via a connection interface to connect the at least one camera based on a driver program for the gateway device, the processing unit configured to receive data from the at least one camera and generate a safety response in response to the data indicating presence of the hotspot; and
a control device configured to receive the data from the gateway device and generate at least one of a report, a warning, and an alarm based on the data.

2. The hotspot detection system of claim 1, wherein the gateway device automatically sets up the at least one camera for use by the gateway device and the control device, and generates an interface in response to connecting the at least one camera to the gateway device.

3. The hotspot detection system of claim 1, wherein the gateway device generates the safety response by activating a fire suppression system.

4. The hotspot detection system of claim 1, wherein the gateway device is connected to the network based on at least one of an Internet connection at a location of the gateway device, an Ethernet network, and a cellular connection.

5. The hotspot detection system of claim 4, wherein the gateway device connected to the network based on the cellular connection lacks a physical connection to at least one external device.

6. The hotspot detection system of claim 1, wherein at least one of the at least one camera, the gateway device, and the control device check the hotspot for a known condition that triggers a false alarm.

7. The hotspot detections system of claim 6, wherein at least one of the gateway device and the control device restrict generation of at least one of the safety response, the warning, and the alarm in response to the false alarm.

8. The hotspot detection system of claim 1, wherein the gateway device further comprises an input/output (I/O) interface to removably connect to at least one of a fire alarm system, a fire suppression system, an audio and visual alarm beacon, and a programmable logic controller (PLC).

9. The hotspot detection system of claim 1, wherein the control device sends notification of at least one of the warning and the alarm over a plurality of messaging platforms.

10. The hotspot detection system of claim 1, wherein the control device displays a map overlay of at least one of the location and the device based on at least one of the report, the warning, and the alarm.

11. The hotspot detection system of claim 1, wherein the gateway device and the control device are disposed in the camera.

12. A hotspot detection system, comprising:
a plurality of sensors configured to monitor at least one of a location and a device, and detect a hotspot at the location and the device based on at least one of a fire, an imminent fire, a temperature level exceeding a threshold temperature level, a flame, and a smoke emission;
a gateway device, comprising:
a base,
a plurality of network connectors disposed on at least a portion of the base to connect to a network and each of the plurality of sensors, and
a processing unit disposed within the base and accessed via a connection interface to connect the plurality of sensors based on a driver program for the gateway device, the processing unit configured to receive data from each of the plurality of sensors and generate a safety response in response to the data indicating presence of the hotspot; and
a control device configured to receive the data from the gateway device and generate at least one of a report, a warning, and an alarm based on the data.

13. The hotspot detection system of claim 12, wherein at least one of the plurality of sensors is an outgassing sensor that monitors at least one of temperature level and a gas emission from a battery.

14. The hotspot detection system of claim 12, wherein at least one of the plurality of sensors is connected to the gateway device over a LoRaWAN gateway.

15. The hotspot detection system of claim 12, wherein the gateway device automatically sets up at least one of the plurality of sensors for use by the gateway device and the control device, and generates an interface specific to each of the plurality of sensors in response to connecting at least one of the plurality of sensors to the gateway device.

16. A control device, comprising:
one or more processing units, the one or more processing units configured to:
receive data from at least one camera that monitors at least one of a location and a device;
generate a map displaying and highlighting each location and each device;
generate at least one of a report, a warning, and an alarm in response to the data indicating presence of a hotspot; and
send notifications to at least one recipient based on real-time information of the hotspot at the location and the device.

17. The control device of claim 16, wherein the one or more processing units sends the notifications as a uniform resource locator (URL) link that is dynamically generated based on real-time information via emails and text messages.

18. The control device of claim 17, wherein the one or more processing units are further configured to include a map view in the URL link of at least one of the fire and the imminent fire at the location and the device.

19. The control device of claim 17, wherein the one or more processing units are further configured to include optimal access points at the location, shut off valves for gas, water, and electricity at the location, and positions of sensors and cameras at the location in the URL link.

20. The control device of claim 16, wherein the one or more processing units are configured to send the notifications to the at least one recipient over a dual-core SIM card in response to at least one of a weak signal and a lost signal.
